(19) United States
(12) Patent Application Publication
(10) Pub. No.: US 2024/0136839 A1
(43) Pub. Date: Apr. 25, 2024

(54) BATTERY, METHOD FOR IMPROVING BATTERY CYCLING PERFORMANCE, ELECTRONIC DEVICE, AND NON-TRANSITORY COMPUTER-READABLE STORAGE MEDIUM

(71) Applicant: ZHUHAI COSMX BATTERY CO., LTD., Zhuhai (CN)

(72) Inventor: Changan ZENG, Zhuhai (CN)

(73) Assignee: ZHUHAI COSMX BATTERY CO., LTD., Zhuhai (CN)

(21) Appl. No.: 18/476,851

(22) Filed: Sep. 28, 2023

(30) Foreign Application Priority Data
Oct. 8, 2022 (CN) 202211243616.2

(51) Int. Cl. H02J 7/00; H01M 10/44

(52) U.S. Cl. CPC H02J 7/0069; H01M 10/443; H02J 7/0048; H02J 7/00714; H02J 7/007182; H02J 7/007194; H01M 2300/0028

(57) ABSTRACT

Disclosed are a battery, a method for improving battery cycling performance, an electronic device, and a non-transitory computer-readable storage medium. The battery includes an electrolyte solution, where the electrolyte solution includes an organic solvent, a lithium salt, a nitrile substance, and a compound represented by Formula 1. The following relationship is satisfied: 0.055≤a≤0.1; 0.03≤b≤0.07; 0.03≤c≤0.05; and 1.7≤(a+b)/c≤5.7, where a denotes a voltage reducing amplitude, in a unit of V, obtained during 45° C. high temperature cycling or 45° C. high temperature interval cycling, b denotes a mass percentage of the nitrile substance, and c denotes a mass percentage of the compound represented by Formula 1. The battery has good 45° C. high temperature cycling performance and 45° C. high temperature interval cycling performance.

### CROSS-REFERENCE TO RELATED APPLICATIONS

The present disclosure claims priority to Chinese Patent Application No. CN202211243616.2, filed on Oct. 8, 2022, which is incorporated herein by reference in its entirety.

### TECHNICAL FIELD

The present disclosure pertains to the field of battery technologies, and more specifically, to a battery, a method for improving battery cycling performance, an electronic device, and a non-transitory computer-readable storage medium.

### BACKGROUND

Since lithium-ion batteries have been commercialized, they are widely used in fields such as digital field, energy storage, power, military aerospace, and communications devices because of their lightness and convenience, high specific energy, memory-free effect, and good cycling performance. With widespread application of lithium-ion batteries, consumers impose higher requirements on performance such as energy density, cycle life, high-temperature performance, and safety of lithium-ion batteries.

It is found through research that energy density of a battery may be improved by increasing a charging voltage of a positive electrode. However, as the charging voltage increases, an amount of lithium deintercalated from a surface of a positive electrode increases. In this case, an irreversible phase transition of a rock salt phase or a spinel phase occurs on the positive electrode surface; and transition metal ions on the surface of the positive electrode have a higher oxidation property, and an electrolyte solution is more prone to oxidative decomposition. In addition, a partial hydrofluoric acid HF is generated due to decomposition of the electrolyte solution itself, and the HF reacts with the transition metal ions, resulting in dissolution of the transition metal ions. The eluted transition metal ions migrate to a negative electrode, and destroy SEI of the negative electrode. The foregoing causes result in that a high-voltage system battery has poor 45° C. high temperature cycling performance and 45° C. interval cycling performance.

### SUMMARY

To improve deficiencies in a conventional technology, a first aspect of the present disclosure provides a battery, and an electrolyte solution of the battery includes a nitrile substance and a compound represented by Formula 1, and has a specific electrolyte solution formula combination and cooperates with a specific voltage reducing amplitude. The battery has good 45° C. high temperature cycling performance and 45° C. high temperature interval cycling performance.

A second aspect of the present disclosure further provides a method for improving battery cycling performance, including: performing cyclic charging and discharging on a battery (for example, the battery in the first aspect) in a range of a first preset voltage; when a quantity of cycles is within a preset quantity of cycles, reducing the first preset voltage by a preset amplitude to obtain a second preset voltage, where a value of the preset amplitude ranges from 0.055 V to 0.1 V; and performing charging and discharging on the battery in a range of the second preset voltage.

A third aspect of the present disclosure further provides an electronic device, including a memory and a processor, where the memory stores a computer program. When executing the computer program, the processor performs the following steps: performing cyclic charging and discharging on a battery (for example, the battery in the first aspect) in a range of a first preset voltage; when a quantity of cycles is within a preset quantity of cycles, reducing the first preset voltage by a preset amplitude to obtain a second preset voltage, where a value of the preset amplitude ranges from 0.055 V to 0.1 V; and performing charging and discharging on the battery in a range of the second preset voltage.

A fourth aspect of the present disclosure further provides a non-transitory computer-readable storage medium on which a computer program is stored. When the computer program is executed by a processor, the following steps are performed: performing cyclic charging and discharging on a battery (for example, the battery in the first aspect) in a range of a first preset voltage; when a quantity of cycles is within a preset quantity of cycles, reducing the first preset voltage by a preset amplitude to obtain a second preset voltage, where a value of the preset amplitude ranges from 0.055 V to 0.1 V; and performing charging and discharging on the battery in a range of the second preset voltage.

The present disclosure is implemented by using the following technical solution:
a battery, where the battery includes an electrolyte including an organic solvent, a lithium salt, a nitrile substance, and a compound represented by Formula 1;

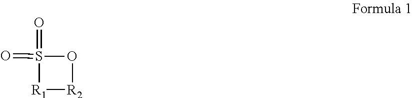

where R₁ is non-existent or selected from an —O— or C₂₋₆ alkenylene group, R₂ is non-existent or selected from a C₁₋₆ alkylidene or C₂₋₆ alkenylene group, and R₁ and R₂ are not non-existent simultaneously and are not a C₂₋₆ alkylene group simultaneously; and
the battery satisfies the following relationship:

0.055≤a≤0.1;0.03≤b≤0.07;0.03≤c≤0.05; and 1.7≤(a+b)/c≤5.7,
where a denotes a voltage reducing amplitude, in a unit of V, obtained during 45° C. high temperature cycling or 45° C. high temperature interval cycling;
b denotes a percentage of a mass of the nitrile substance in the electrolyte solution in a total mass of the electrolyte solution; and
c denotes a percentage of a mass of the compound represented by Formula 1 in the electrolyte solution in a total mass of the electrolyte solution.

A capacity retention rate of the battery is not less than 79.2% after 500 cycles in 45° C. high temperature cycling, and/or a capacity retention rate of the battery is not less than 77.3% after 100 cycles in high temperature interval cycling,

After 500 cycles in 45° C. high temperature cycling, the capacity retention rate of the battery is not less than 79.2%, for example, not less than 79.5%, not less than 79.8%, not less than 80%, not less than 80.2%, not less than 80.5%, not less than 80.8%, not less than 81%, not less than 81.2%, or not less than 81.5%.

After 100 cycles in high temperature interval cycling, the capacity retention rate of the battery is not less than 77.3%, for example, not less than 77.5%, not less than 77.8%, not less than 78.0%, not less than 78.2%, not less than 78.5%, not less than 78.8%, not less than 79.0%, not less than 79.2%, or not less than 79.5%.

After 500 cycles in 45° C. high temperature cycling, a thickness change rate of the battery is not greater than 9.2%, for example, not greater than 9.0%, not greater than 8.8%, not greater than 8.5%, not greater than 8.2%, not greater than 8.0%, not greater than 7.8%, not greater than 7.5%, or not greater than 7.2%.

After 100 cycles in high temperature interval cycling, the thickness change rate of the battery is not greater than 9.1%, for example, not greater than 9.0%, not greater than 8.8%, not greater than 8.5%, not greater than 8.2%, not greater than 8.0%, not greater than 7.8%, not greater than 7.5%, not greater than 7.2%, or not greater than 7.0%.

In Formula 1, b and c denote the percentages in a decimal form. For example, when the percentage of the mass of the nitrile substance in the electrolyte solution in the total mass of the electrolyte solution is 5%, b=0.05; and when the percentage of the mass of the compound represented by Formula 1 in the electrolyte solution in the total mass of the electrolyte solution is 4%, c=0.04.

According to the present disclosure, a voltage reduction strategy (namely, the voltage reduction method) used for the battery in the 45° C. high temperature cycling is as follows: performing full charge and discharge initially in a corresponding voltage range; and after 150-200 cycles, performing voltage reduction and continuing to cycle, where the voltage reducing amplitude, namely a, ranges from 0.055 V to 0.1 V (for example, 0.055 V, 0.06 V, 0.065 V, 0.07 V, 0.075 V, 0.08 V, 0.085 V, 0.09 V, 0.095 V, or 0.1 V; and in an example, a ranges from 0.056 V to 0.08 V).

According to the present disclosure, a voltage reduction strategy used for the battery in the 45° C. high temperature interval cycling is as follows: performing full charge and discharge initially in a corresponding voltage range; and after 20-25 cycles, performing voltage reduction and continuing to cycle, where the voltage reducing amplitude, namely a, ranges from 0.055 V to 0.1 V (for example, 0.055 V, 0.06 V, 0.065 V, 0.07 V, 0.075 V, 0.08 V, 0.085 V, 0.09 V, 0.095 V, 0.1 V, or a range formed by any two of the values; and in an example, a ranges from 0.056 V to 0.08 V).

According to the present disclosure, an upper limit voltage for operation of the battery is greater than or equal to 4.48 V (for example, 4.48 V, 4.5 V, 4.51, 4.52 V, 4.53 V, 4.54 V, 4.55 V, 4.56 V, 4.57 V, 4.58 V, 4.59 V, 4.6 V, 4.61 V, 4.62 V, 4.63 V, 4.64 V, 4.65 V, 4.66 V, 4.67 V, 4.68 V, 4.69 V, or 4.70 V).

According to the present disclosure, the nitrile substance is selected from one or more of the following compounds: succinonitrile, glutaronitrile, adiponitrile, pimeliconitrile, suberonitrile, sebaconitrile, 1,3,6-hexanetricarbonitrile, 3-methoxypropionitrile, glycerol trinitrile, or 1,2-bis(2-cyanoethoxy)ethane.

According to the present disclosure, in Formula 1, R₁ is non-existent or selected from an —O— or C₂₋₃ alkenylene group, R₂ is non-existent or selected from a C₁₋₃ alkylidene or C₂₋₃ alkenylene group, and R₁ and R₂ are not both non-existent and are not both a C₂₋₃ alkylene group.

In the present disclosure, when a group (namely, R₁ or R₂) is non-existent, it means that groups on two sides of the group are directly connected. For example, when R₁ is non-existent, S and R₂ are directly connected.

In the present disclosure, “C₂₋₃ alkenylene group” is selected from, for example, —C═C—, —C—C═C—, —C═C—C—, —C═C(C)—, or —C(C)═C— in a left or right direction.

In the present disclosure, “C₁₋₃ alkylidene group” is selected from, for example, —C—, —C—C—, —C—C—C—, or —C(C)—C—.

According to the present disclosure, the compound represented by Formula 1 is selected from one or more of the following compounds: 1,3-propane sultone, 1,3-propene sultone, or ethylene sulfate.

According to the present disclosure, the organic solvent is selected from one or more of carbonate and/or carboxylate.

For example, the carbonate is selected from one or more of the following fluorinated or unsubstituted solvents: ethylene carbonate, propylene carbonate, dimethyl carbonate, diethyl carbonate, or ethyl methyl carbonate.

For example, the carboxylate is selected from one or more of the following fluorinated or unsubstituted solvents: propyl acetate, n-butyl acetate, isobutyl acetate, n-amyl acetate, isoamyl acetate, propyl propionate, n-propyl propionate, methyl butyrate, and ethyl butyrate.

According to the present disclosure, the electrolyte solution further includes one or more of the following additives: vinylene carbonate, vinyl ethylene carbonate, fluoroethylene carbonate, ethylene sulphite, methylene methanedisulfonate, or ethylene sulfate.

A percentage of a mass of the additive in the total mass of the electrolyte solution may range from 5% to 15%, for example, may be 5%, 6%, 7%, 8%, 9%, 10%, 11%, 12%, 13%, 14%, or 15%.

According to the present disclosure, the lithium salt of the electrolyte solution is selected from one or more of lithium hexafluorophosphate, lithium difluorophosphate, lithium difluoro(oxalato)borate, lithium bis(fluorosulfonyl)imide, lithium bis(trifluoromethanesulfonyl)imide, lithium difluorobis(oxalato)phosphate, lithium tetrafluoroborate, lithium bisoxalate borate, lithium hexafluoroantimonate, lithium hexafluoroarsenate, lithium bis (trifluoromethylsulfonyl)imine, lithium bis (pentafluoroethylsulfonyl)imine, tri(trifluoromethyl sulfonyl) methyllithium, or lithium bis(trifluoromethyl sulfonyl)imine.

A percentage of a mass of the lithium salt in the total mass of the electrolyte solution may range from 10% to 20%, for example, may be 10%, 11%, 12%, 13%, 14%, 15%, 16%, 17%, 18%, 19%, 20%, or a range therebetween. In an example, the percentage of the mass of the lithium salt in the total mass of the electrolyte solution ranges from 12% to 16%.

The percentage b of the mass of the nitrile substance in the electrolyte solution in the total mass of the electrolyte solution is denoted (in a decimal form), and a value of b ranges from 0.03 to 0.07, for example, is 0.03, 0.035, 0.04, 0.045, 0.05, 0.055, 0.06, 0.065, 0.07, or a range formed by any two of the values. In an example, b ranges from 0.04 to 0.06.

The percentage c of the mass of the compound represented by Formula 1 in the electrolyte solution in the total mass of the electrolyte solution is denoted (in a decimal form), and a value of c ranges from 0.03 to 0.05, for example, is 0.03, 0.035, 0.04, 0.045, 0.05, or a range formed by any two of the values.

The values of a, b, and c make (a+b)/c be in a range of 1.7-5.7, for example, is 1.7, 2, 2.5, 3, 3.5, 4, 4.5, 5, 5.5, 5.7, or a range formed by any two of the values. In an example, (a+b)/c ranges from 2.44 to 3.83.

According to the present disclosure, the battery further includes a positive electrode plate containing a positive electrode active material, a negative electrode plate containing a negative electrode active material, and a lithium-ion separator.

According to the present disclosure, the positive electrode active material is selected from one or more of a layered lithium composite oxide, lithium manganate, or a ternary material. A chemical formula of the layered lithium composite oxide is Li₍₁₊ₓ₎Ni_{y}Co_{z}M_{(1-y-z)}O₂, where −0.1≤x≤1; 0≤y≤1, 0≤z≤1, and 0≤y+z≤1; and M is one or more of Mg, Zn, Ga, Ba, Al, Fe, Cr, Sn, V, Mn, Sc, Ti, Nb, Mo, or Zr.

According to the present disclosure, the negative electrode active material is selected from one or more of a carbon-based material, a silicon-based material, a tin-based material, or an alloy material corresponding thereto.

The present disclosure further provides a method for improving 45° C. high temperature cycling performance and 45° C. high temperature interval cycling performance for a battery, where the battery is the battery described above, and the method includes the following steps:
performing charge and discharge on the battery in high temperature cycling at 45° C.; when cycling of the battery starts, performing normal full charge and discharge in a corresponding voltage range; and after 150-200 cycles (for example, 150 cycles, 160 cycles, 170 cycles, 180 cycles, 190 cycles, 200 cycles, or a range formed by any two of the values), using a voltage reduction strategy, where a voltage reducing amplitude is a V; and/or
performing charge and discharge on the battery in high temperature interval cycling at 45° C.; when cycling of the battery starts, performing normal full charge and discharge in a corresponding voltage range; and after 20-25 cycles (for example, 20 cycles, 21 cycles, 22 cycles, 23 cycles, 24 cycles, 25 cycles, or a range formed by any two of the values), using a voltage reduction strategy, where a voltage reducing amplitude is a V.

In the present disclosure, the method for improving 45° C. high temperature cycling performance and 45° C. high temperature interval cycling performance for a battery may be implemented in various manners, for example, may be performed by an electronic device in which the battery is located.

According to the present disclosure, a value of a is independently selected when a voltage reduction strategy is used in charge and discharge in high temperature cycling and in charge and discharge in high temperature interval cycling.

During charge and discharge in high temperature cycling, the value of a ranges from 0.055 V to 0.1 V, for example, is 0.055 V, 0.06 V, 0.065 V, 0.07 V, 0.075 V, 0.08 V, 0.085 V, 0.09 V, 0.095 V, 0.1 V, or a range formed by any two of the values.

During charge and discharge in high temperature interval cycling, the value of a ranges from 0.055 V to 0.1 V, for example, is 0.055 V, 0.06 V, 0.065 V, 0.07 V, 0.075 V, 0.08 V, 0.085 V, 0.09 V, 0.095 V, 0.1 V, or a range formed by any two of the values.

In an example of charge and discharge in high temperature cycling, a 4.5 V system is used as an example, and the method includes the following steps:
letting the battery stand for 2-6 hours (preferably 2-4 hours) in an environment of (45±3°) C.; when a cell body reaches (45±3°) C., charging the battery to a first voltage (for example, (4.5±0.05) V) at a constant current ranging from 0.5 C to 1.5 C (preferably 0.6 C-1 C), then charging to a cut-off current ranging from 0.02 C to 0.07 C (preferably 0.025 C-0.05 C) in a constant voltage manner at the first voltage, then discharging at 0.3 C-1.5 C (preferably 0.4 C-1 C), and repeating the cycle; and after 150-200 cycles, charging the battery to a second voltage (the second voltage=the first voltage−a) at a constant current ranging from 0.5 C to 1.5 C (preferably 0.6 C-1 C), then charging to a cut-off current ranging from 0.02 C to 0.07 C (preferably 0.025 C-0.05 C) in a constant voltage manner at the second voltage, then discharging at 0.3 C-1.5 C (preferably 0.4 C-1 C), and repeating the cycle.

In an example of charge and discharge in high temperature cycling, a 4.5 V system is used as an example, and the method includes the following steps:
letting the battery stand for three hours in an environment of (45±3°) C.; when a cell body reaches (45±3°) C., charging the battery to 4.5 V at a constant current 0.7 C, then charging to a cut-off current 0.05 C at a constant voltage 4.5 V, then discharging to 0.5 C, and repeating the cycle; and after 150-200 cycles, using a voltage reduction strategy, where a voltage reducing amplitude ranges from 0.055 V to 0.1 V, that is, charging the battery to 4.4-4.495 V at a constant current 0.7 C, then charging to a cut-off current 0.05 C at a constant voltage ranging from 4.4 V to 4.495 V, then discharging to 0.5 C, and repeating the cycle.

In an example of charge and discharge in high temperature interval cycling, a 4.5 V system is used as an example, and the method includes the following steps:
letting the battery stand for 2-6 hours (preferably 2-4 hours) in an environment of (45±3°) C.; when a cell body reaches (45±3°) C., charging the battery to a first voltage (for example, (4.5±0.05) V) at a constant current ranging from 0.5 C to 1.5 C (preferably 0.6 C-1 C), then charging to a cut-off current ranging from 0.02 C to 0.07 C (preferably 0.025 C-0.05 C) in a constant voltage mannerat the first voltage; letting the battery stand at 45° C. for a specific period of time to ensure a constant-current constant-voltage charging time plus the standing time of 20-30 hours (preferably 22-26 hours), then discharging the battery at 0.3 C-1.5 C (preferably 0.4 C-1 C), and repeating the cycle; after 20-25 cycles, charging the battery to a second voltage (the second voltage=the first voltage−a) at a constant current ranging from 0.5 C to 1.5 C (preferably 0.6 C-1 C), then charging to a cut-off current ranging from 0.02 C to 0.07 C (preferably 0.025 C-0.05 C) in a constant voltage manner at the second voltage; and letting the battery stand at 45° C. for a specific period of time to ensure a constant-current constant-voltage charging time plus the standing time of 20-30 hours (preferably 22-26 hours), then discharging the battery at 0.3 C-1.5 C (preferably 0.4 C-1 C), and repeating the cycle.

In an example of charge and discharge in high temperature interval cycling, a 4.5 V system is used as an example, and the method includes the following steps:
letting the battery stand for three hours in an environment of (45±3°) C.; when the cell body reaches (45±3°) C., charging the battery to 4.5 V at a constant current 0.7 C, and then charging to a cut-off current 0.05 C at a constant voltage 4.5 V; standing at 45° C. for a specific period of time to ensure a constant-current constant-voltage charging time plus the standing time of 24 hours, then discharging at 0.5 C, and repeating the cycle; after 20-25 cycles, using a voltage reduction strategy, where a voltage reducing amplitude ranges from 0.055 V to 0.1 V, that is, charging the battery to 4.4-4.495 V at a constant current 0.7 C, then charging to a cut-off current 0.05 C at a constant voltage ranging from 4.4 V to 4.495 V; standing at 45° C. for a specific period of time to ensure a constant-current constant-voltage charging time plus the standing time of 24 hours, then discharging at 0.5 C; and repeating the cycle.

The present disclosure further provides a method for improving battery cycling performance, including: performing cyclic charging and discharging on a battery (for example, the battery in the first aspect) in a range of a first preset voltage; when a quantity of cycles is within a preset quantity of cycles, reducing the first preset voltage by a preset amplitude to obtain a second preset voltage, where a value of the preset amplitude ranges from 0.055 V to 0.1 V; and performing charging and discharging on the battery in a range of the second preset voltage.

According to the present disclosure, the performing cyclic charging and discharging on the battery in a range of a first preset voltage includes: (A) performing constant-current charging on the battery by using a first preset current until the battery is charged to the first preset voltage; (B) performing constant-voltage charging on the battery by using the first preset voltage until the battery is charged to a cut-off current; (C) discharging the battery by using a second preset current; and iteratively performing steps (A) to (C) to complete cyclic charging and discharging of the battery.

According to the present disclosure, the performing charging and discharging on the battery in a range of the second preset voltage includes: performing constant-current charging on the battery by using the first preset current until the battery is charged to the second preset voltage; performing constant-voltage charging on the battery by using the second preset voltage until the battery is charged to the cut-off current; and discharging the battery by using the second preset current.

According to the present disclosure, the preset quantity of cycles ranges from 150 to 200.

According to the present disclosure, the performing cyclic charging and discharging on the battery in a range of a first preset voltage includes: (D) performing constant-current charging on the battery by using a third preset current until the battery is charged to the first preset voltage; (E) performing constant-voltage charging on the battery by using the first preset voltage until the battery is charged to a cut-off current; (F) discharging the battery by using a fourth preset current when a sum of a duration of the constant-current charging, a duration of the constant-voltage charging, and a first time is within a preset time threshold, where the first time is a duration during which the battery stays at a preset temperature after constant-voltage charging; and Iteratively performing steps (D) to (F) to complete cyclic charging and discharging of the battery.

According to the present disclosure, the performing charging and discharging on the battery in a range of the second preset voltage includes: performing constant-current charging on the battery by using the third preset current until the battery is charged to the second preset voltage; performing constant-voltage charging on the battery by using the second preset voltage until the battery is charged to the cut-off current; and discharging the battery by using the fourth preset current when a sum of the duration of the constant-current charging, the duration of the constant-voltage charging, and a second time is within the preset time threshold, where the second time is a duration during which the battery stays at the preset temperature after constant-voltage charging.

According to the present disclosure, the preset quantity of cycles ranges from 20 to 25.

According to the present disclosure, the method for improving battery cycling performance further includes: determining a sum of the first time, a duration of the constant-current charging, and a duration of the constant-voltage charging used when cyclic charging and discharging is performed on the battery in a range of the first preset voltage; and determining a sum of the second time, the duration of the constant-current charging, and the duration of the constant-voltage charging used when cyclic charging and discharging is performed on the battery in a range of the second preset voltage.

According to the present disclosure, the preset time threshold ranges from 20 hours to 30 hours.

According to the present disclosure, the method for improving battery cycling performance further includes: measuring a temperature of the battery occurred after the battery is left at a preset temperature for a preset time.

According to the present disclosure, the performing cyclic charging and discharging on the battery in a range of a first preset voltage includes: after the temperature of the battery reaches the preset temperature, performing cyclic charging and discharging on the battery in the range of the first preset voltage.

An embodiment of the present disclosure further provides an electronic device, including a memory and a processor, where the memory stores a computer program. When executing the computer program, the processor implements the method in any one of the foregoing embodiments. In this embodiment, the processor and the memory transmit data by using a data bus.

In this embodiment, the electronic device may further include a network interface, and data exchange between the electronic device and an external device may be implemented by using the network interface.

An embodiment of the present disclosure further provides an electronic device, including a memory and a processor, where the memory stores a computer program. When executing the computer program, the processor performs the following steps:
performing cyclic charging and discharging on a battery (for example, the battery in the first aspect) in a range of a first preset voltage;
when a quantity of cycles is within a preset quantity of cycles, reducing the first preset voltage by a preset amplitude to obtain a second preset voltage, where a value of the preset amplitude ranges from 0.055 V to 0.1 V; and
performing charging and discharging on the battery in a range of the second preset voltage.

An embodiment of the present disclosure further provides a non-transitory computer-readable storage medium on which a computer program is stored. When the computer program is executed by a processor, the method in any one of the foregoing embodiments is implemented.

An embodiment of the present disclosure further provides a non-transitory computer-readable storage medium on which a computer program is stored. When the computer program is executed by a processor, the following steps are performed:
performing cyclic charging and discharging on a battery (for example, the battery in the first aspect) in a range of a first preset voltage;
when a quantity of cycles is within a preset quantity of cycles, reducing the first preset voltage by a preset amplitude to obtain a second preset voltage, where a value of the preset amplitude ranges from 0.055 V to 0.1 V; and
performing charging and discharging on the battery in a range of the second preset voltage.

Beneficial effects of the present disclosure are as follows:

The present disclosure provides a battery, and the battery uses a special charge and discharge method. At a high voltage, adding an appropriate amount of a nitrile substance into an electrolyte solution may better protect a positive electrode, complex transition metal ions on a surface of the positive electrode, and reduce dissolution of the transition metal ions. The appropriate amount of the nitrile substance can better stabilize the positive electrode, and may also ensure that a film forming impedance thereof is relatively low, thereby improving performance of the battery and also considering lithium ion migration kinetics. Adding a compound represented by Formula 1 into the electrolyte solution may form a stable SEI film on a negative electrode, stabling the negative electrode, and reducing damage to the negative electrode caused by the dissolution of the transition metal ions. In addition, there is a specific film forming or protection effect on the positive electrode, having some benefits for improving high temperature cycling of the battery. Moreover, when high temperature cycling or high temperature interval cycling reaches a specific number of cycles, a voltage reduction and cycling strategy with a specific voltage reducing amplitude is used to prevent the battery from keeping a high voltage state all the time during charging, which may reduce phase transition and dissolution of the transition metal ions indicated by the positive electrode at a high voltage for a long time and oxidative decomposition of the electrolyte solution, thereby improving performance of the battery. In addition, an appropriate amount of voltage reducing amplitude is used, so that a service life of the battery may be obviously prolonged without greatly affecting use experience of a consumer.

### BRIEF DESCRIPTION OF THE DRAWINGS

FIG. 1 is a schematic flowchart of a method for improving battery cycling performance according to an embodiment of the present disclosure.

FIG. 2 is a schematic structural diagram of an electronic device according to an embodiment of the present disclosure.

### DETAILED DESCRIPTIONS OF THE EMBODIMENTS

The present disclosure is further described in detail below with reference to specific embodiments. It should be understood that the following embodiments are merely for the purposes of illustrating and explaining the present disclosure, and should not be construed as limiting the protection scope of the present disclosure. Any technology implemented based on the foregoing contents of the present disclosure falls within the intended protection scope of the present disclosure.

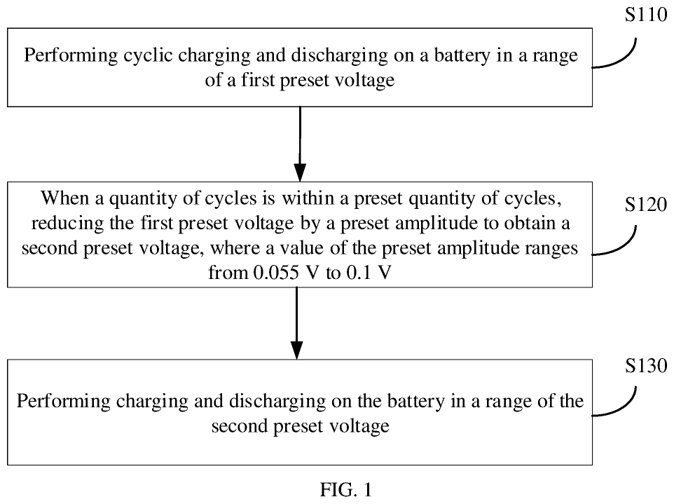

FIG. 1 is a schematic flowchart of a method for improving battery cycling performance according to an embodiment of the present disclosure. With reference to FIG. 1, the following describes in more detail the method for improving battery cycling performance in the embodiment of the present disclosure. The method in FIG. 1 is executed by a computing device (for example, a server), which is not limited in the present disclosure. As shown in FIG. 1, the method includes the following steps.

S110: Performing cyclic charging and discharging on a battery in a range of a first preset voltage.

In an example, the first preset voltage ranges from 4.45 V to 4.55 V.

S120: When a quantity of cycles is within a preset quantity of cycles, reducing the first preset voltage by a preset amplitude to obtain a second preset voltage, where a value of the preset amplitude ranges from 0.055 V to 0.1 V.

In an example, the second preset voltage is the first preset voltage minus the preset amplitude a, and a value of the preset amplitude a ranges from 0.055 V to 0.1 V.

The preset quantity of cycles may be set to different values depending on different modes of cyclic charging and discharging. For example, for high-temperature cyclic charging and discharging, the preset quantity of cycles ranges from 150 to 200. For another example, for high-temperature interval cyclic charging and discharging, the preset quantity of cycles ranges from 20 to 25.

S130: Performing charging and discharging on the battery in a range of the second preset voltage.

In an embodiment, charging and discharging are performed on the battery in high temperature cycling at 45° C. When cyclic charging and discharging of the battery starts, the battery is normally fully charged and discharged in the range of the first preset voltage. After 150-200 cycles of charging and discharging of the battery, a voltage reduction strategy is used to reduce the first preset voltage by a preset amplitude, to obtain the second preset voltage. Thereafter, the battery is normally fully charged and discharged in the range of the second preset voltage.

In another embodiment, charging and discharging are performed on the battery in high temperature interval cycling at 45° C. When cyclic charging and discharging of the battery starts, the battery is normally fully charged and fully discharged intermittently in the range of the first preset voltage. After 20-25 cycles of charging and discharging of the battery, a voltage reduction strategy is used to reduce the first preset voltage by a preset amplitude, to obtain the second preset voltage. Thereafter, the battery is normally fully charged and discharged intermittently in the range of the second preset voltage.

According to the present disclosure, the preset amplitudes a are independently valued. For example, during charging and discharging in high temperature cycling, a ranges from 0.055 V to 0.1 V, for example, is 0.055 V, 0.06 V, 0.065 V, 0.07 V, 0.075 V, 0.08 V, 0.085 V, 0.09 V, 0.095 V, 0.1 V, or a range formed by any two of the values. For another example, during charging and discharging in high temperature interval cycling, a ranges from 0.055 V to 0.1 V, for example, is 0.055 V, 0.06 V, 0.065 V, 0.07 V, 0.075 V, 0.08 V, 0.085 V, 0.09 V, 0.095 V, 0.1 V, or a range formed by any two of the values.

In an embodiment of the present disclosure, the performing cyclic charging and discharging on a battery in a range of a first preset voltage includes: (A) performing constant-current charging on the battery by using a first preset current until the battery is charged to the first preset voltage; (B) performing constant-voltage charging on the battery by using the first preset voltage until the battery is charged to a cut-off current; (C) discharging the battery by using a second preset current; and iteratively performing steps (A) to (C) to complete cyclic charging and discharging of the battery. The performing charging and discharging on the battery in a range of the second preset voltage includes: performing constant-current charging on the battery by using the first preset current until the battery is charged to the second preset voltage; performing constant-voltage charging on the battery by using the second preset voltage until the battery is charged to the cut-off current; and discharging the battery by using the second preset current.

In this embodiment, the following uses a 4.5 V system as an example to describe a process of charge and discharge in high temperature cycling.

A battery is placed in an environment of (45±3°) C. for 2-6 hours (preferably 2-4 hours). When a cell body reaches (45±3°) C., the battery is charged to a first preset voltage (for example, (4.5±0.05) V) in a constant current manner at a first preset current, for example, 0.5 C-1.5 C (preferably 0.6 C-1 C), then charged to a cut-off current, for example, 0.02 C-0.07 C (preferably 0.025 C-0.05 C) in a constant voltage manner at the first preset voltage, and then discharged at a second preset current, for example, 0.3 C-1.5 C (preferably 0.4 C-1 C). The cycle is repeated. After 150-200 cycles, the battery is charged to a second preset voltage (second preset voltage=first preset voltage−preset amplitude a) in a constant current manner at the first preset current, for example, 0.5 C-1.5 C (preferably 0.6 C-1 C), then charged to a cut-off current, for example, 0.02 C-0.07 C (preferably 0.025 C-0.05 C) in a constant voltage manner at the second preset voltage, and then discharged at the second preset current, for example, 0.3 C-1.5 C (preferably 0.4 C-1 C). The cycle is repeated.

The following uses a 4.5 V system as a specific example to describe a process of charge and discharge in high temperature cycling.

A battery is placed in an environment of (45±3°) C. for 3 hours. When a cell body reaches (45±3°) C., the battery is charged to a first preset voltage 4.5 V in a constant current manner at a first preset current 0.7 C, then charged to a cut-off current 0.05 C in a constant voltage manner at the first preset voltage 4.5V, and then discharged at a second preset current 0.5 C. The cycle is repeated. After 150-200 cycles, a voltage reduction strategy is used to reduce the first preset voltage, where a voltage reducing amplitude ranges from 0.055 V to 0.1 V. After that, the battery is charged to a second preset voltage 4.4 V-4.495 V in a constant current manner at the first preset current 0.7 C, then charged to a cut-off current 0.05 C in a constant voltage manner at the second preset voltage 4.4 V-4.495 V, and then discharged at the second preset current 0.5 C. The cycle is repeated.

In an embodiment of the present disclosure, the performing cyclic charging and discharging on a battery in a range of a first preset voltage includes: (D) performing constant-current charging on the battery by using a third preset current until the battery is charged to the first preset voltage; (E) performing constant-voltage charging on the battery by using the first preset voltage until the battery is charged to a cut-off current; (F) discharging the battery by using a fourth preset current when a sum of a duration of the constant-current charging, a duration of the constant-voltage charging, and a first time is within a preset time threshold, where the first time is a duration during which the battery stays at a preset temperature after constant-voltage charging; and Iteratively performing steps (D) to (F) to complete cyclic charging and discharging of the battery. The performing charging and discharging on the battery in a range of the second preset voltage includes: performing constant-current charging on the battery by using the third preset current until the battery is charged to the second preset voltage; performing constant-voltage charging on the battery by using the second preset voltage until the battery is charged to the cut-off current; and discharging the battery by using the fourth preset current when a sum of the duration of the constant-current charging, the duration of the constant-voltage charging, and a second time is within the preset time threshold, where the second time is a duration during which the battery stays at the preset temperature after constant-voltage charging.

In this embodiment, the following uses the 4.5V system as an example to describe a process of charge and discharge in high temperature interval cycling.

A battery is placed in an environment of (45±3°) C. for 2-6 hours (preferably 2-4 hours). When a cell body reaches (45±3°) C., the battery is charged to a first preset voltage, for example, (4.5±0.05) V in a constant current manner at a third preset current, for example, 0.5 C-1.5 C (preferably 0.6 C-1 C), and then charged to a cut-off current, for example, 0.02 C-0.07 C (preferably 0.025 C-0.05 C) in a constant voltage manner at the first preset voltage. The battery is placed at 45° C. for a first time to ensure that a sum of a duration of the constant-current charging, a duration of the constant-voltage charging, and the first time is within a preset time threshold, and the preset time threshold ranges from 20 to 30 hours (preferably 22-26 hours). Then the battery is discharged at a fourth preset current, for example, 0.3 C-1.5 C (preferably 0.4 C-1 C), and the cycle is repeated. After 20-25 cycles, the battery is charged to a second preset voltage (second preset voltage=first preset voltage−preset amplitude a) in a constant current manner at the third preset current, for example, 0.5 C-1.5 C (preferably 0.6 C-1 C), and then charged to a cut-off current, for example, 0.02 C-0.07 C (preferably 0.025 C-0.05 C) in a constant voltage manner at the second preset voltage. The battery is placed at 45° C. for a second time to ensure that a sum of the duration of the constant-current charging, the duration of the constant-voltage charging, and the second time is within a preset time threshold, and the preset time threshold ranges from 20 to 30 hours (preferably 22-26 hours). Then the battery is discharged at a fourth preset current, for example, 0.3 C-1.5 C (preferably 0.4 C-1 C), and the cycle is repeated.

The following uses a 4.5 V system as a specific example to describe a process of charge and discharge in high temperature interval cycling.

The battery is placed in an environment of (45±3°) C. for three hours. When a cell body reaches (45±3°) C., the battery is charged to a first preset voltage 4.5 V in a constant current manner at a third preset current 0.7 C, and then charged to a cut-off current 0.05 C in a constant voltage manner at the first preset voltage 4.5V. The battery is placed at 45° C. for a first time to ensure that a sum of a duration of the constant-current charging, a duration of the constant-voltage charging, and the first time is 24 hours. Then the battery is discharged at a fourth preset current 0.5 C, and the cycle is repeated. After 20-25 cycles, a voltage reduction strategy is used to reduce the first preset voltage, and a voltage reducing amplitude ranges from 0.055 V to 0.1 V. After that, the battery is charged to a second preset voltage ranging from 4.4 V to 4.495 V in a constant current manner at the third preset current 0.7 C, and then charged to a cut-off current 0.05 C in a constant voltage manner at the second preset voltage ranging from 4.4 V to 4.495 V. The battery is placed at 45° C. for a second time to ensure that a sum of the duration of the constant-current charging, the duration of the constant-voltage charging, and the second time is 24 hours. Then the battery is discharged at a fourth preset current 0.5 C, and the cycle is repeated.

In an embodiment of the present disclosure, a method for improving battery cycling performance further includes: determining a sum of the first time, a duration of the constant-current charging, and a duration of the constant-voltage charging used when cyclic charging and discharging is performed on the battery in a range of the first preset voltage; and determining a sum of the second time, a duration of the constant-current charging and the duration of the constant-voltage charging used when cyclic charging and discharging is performed on the battery in a range of the second preset voltage.

A time at which the fourth preset current is used to discharge the battery can be determined by determining a sum of durations at different stages (that is, a stage of cyclic charging and discharging for the battery in the range of the first preset voltage, and a stage of cyclic charging and discharging for the battery in the range of the second preset voltage). The first time and the second time may be the same or different, which is not specifically limited in the present disclosure.

In an embodiment of the present disclosure, the method for improving battery cycling performance further includes: measuring a temperature of the battery occurred after the battery is left at a preset temperature for a preset time.

A time at which cyclic charging and discharging for the battery in the range of the first preset voltage starts can be determined by measuring a temperature of a battery occurred after the battery is left at a preset temperature (for example, 45° C.) for a preset time (for example, 2-6 hours (preferably, 2-4 hours)). In other word, only when the temperature of the battery reaches the preset temperature, the battery starts to be cyclically charged and discharged in the range of the first preset voltage.

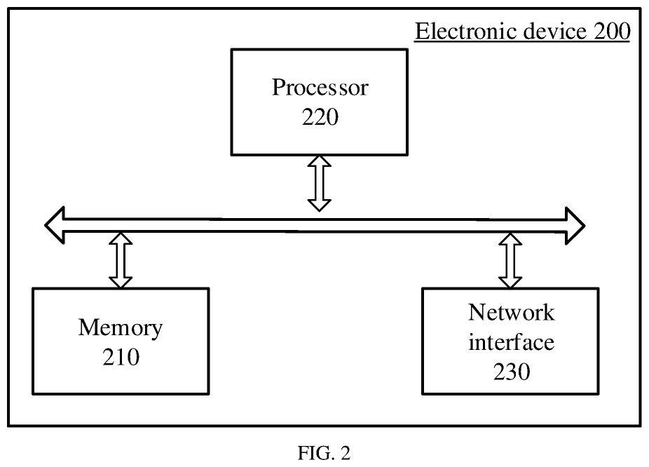

FIG. 2 is a schematic structural diagram of an electronic device according to an embodiment of the present disclosure. The electronic device 200 shown in FIG. 2 may be, for example, a computing device with a computing function. For example, the electronic device 200 may be a server. The electronic device 200 may include a memory 210 and a processor 220. The memory 210 may be configured to store a computer program. The processor 220 may be configured to execute the computer program stored in the memory 210 to implement the steps in the methods described above. In some embodiments, the electronic device 200 may further include a network interface 230, and data exchange between the electronic device 200 and an external device may be implemented by using the network interface 230. In this embodiment, the processor 220 and the memory 210 transmit data by using a data bus.

An embodiment of the present disclosure further provides a non-transitory computer-readable storage medium on which a computer program is stored. When the computer program is executed by a processor, the processor performs the method for improving battery cycling performance in any one of the foregoing embodiments.

An embodiment of the present disclosure further provides a computer program product that includes instructions. When the instructions are executed by a computer, the computer performs the method for improving battery cycling performance in any one of the foregoing embodiments.

It may be understood that specific examples in this specification are merely intended to help a person skilled in the art better understand the embodiments of the present disclosure, but are not intended to limit the scope of the present disclosure.

It may be understood that in various embodiments of the present disclosure, sequence numbers of the foregoing processes do not mean execution sequences. The execution sequences of the processes should be determined based on functions and internal logic of the processes, and should not be construed as any limitation on the implementation processes of embodiments of the present disclosure.

It may be understood that the embodiments described in the present disclosure may be implemented separately or in combination, which is not limited in embodiments of the present disclosure.

Unless otherwise specified, all technical and scientific terms used in embodiments of the present disclosure have the same meaning as commonly understood by those skilled in the art to which this description belongs. The terms used in this specification are merely for the purpose of describing specific implementations, and are not intended to limit the scope of this specification. The term “and/or” used in this specification includes any and all combinations of one or more related listed items. The singular forms “one”, “the” and “this” used in embodiments of the present disclosure and the appended claims are also intended to include plural forms, unless otherwise specified in the context clearly.

It may be understood that the processor in this embodiment of the present disclosure may be an integrated circuit chip, and has a signal processing capability. In an implementation process, the steps in the foregoing method embodiments may be completed by using an integrated logic circuit of hardware in the processor or an instruction in a form of software. The foregoing processor may be a general-purpose processor, a digital signal processor (DSP), an application-specific integrated circuit (ASIC), a field programmable gate array (FPGA) or another programmable logic device, a discrete gate or transistor logic device, or a discrete hardware component. The methods, steps, and logical block diagrams disclosed in embodiments of the present disclosure may be implemented or executed. The general-purpose processor may be a microprocessor, or the processor may be any conventional processor or the like. Steps of the methods disclosed with reference to embodiments of the present disclosure may be directly executed and completed by a hardware decoding processor, or may be executed and completed by using a combination of hardware and software modules in the decoding processor. The software module may be located in a mature storage medium in the art, for example, a random access memory, a flash memory, a read-only memory, a programmable read-only memory, an electrically erasable programmable memory, or a register. The storage medium is located in a memory. The processor reads information from the memory, and completes the steps of the foregoing methods in combination with hardware in the processor.

It can be understood that the memory in this embodiment of the present disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM). It should be noted that, the memory in the system and methods described in this specification includes but is not limited to these memories and any memory of another proper type.

Persons of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraint conditions of the technical solutions. A person skilled in the art may use different methods to implement the described functions for each specific application, but it should not be considered that the implementation goes beyond the scope of this specification.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this specification, it should be understood that the disclosed system, apparatus, and method may be implemented in another manner. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communications connections may be implemented by using some interfaces. The indirect couplings or communications connections between apparatuses or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected based on an actual requirement, to achieve the objectives of the solutions of embodiments.

In addition, each functional unit in each implementation of this specification may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such understanding, the technical solution in this specification which is essential or a part contributing to a conventional technology or a part of the technical solution may be embodied in the form of a software product. The computer software product is stored in a storage medium and includes a plurality of instructions for enabling a computer device (which may be a personal computer, a server, a network device, or the like) to execute all or some steps of the method according to embodiments of the present disclosure. The foregoing storage medium includes any medium that can store program code, such as a USB flash drive, a removable hard disk, a read-only memory (ROM), a random access memory (RAM), a magnetic disk, or an optical disc.

Experimental methods used in the following examples are conventional methods, unless otherwise specified. Reagents, materials, and the like used in the following examples are all commercially available, unless otherwise specified.

### Comparative Example 1

Preparation of a Positive Electrode Plate

A positive electrode active material 4.5 V lithium cobaltate (LiCoO₂), a binder polyvinylidene fluoride (PVDF), and a conductive agent acetylene black were mixed at a weight ratio of 98:1.5:0.5, and were added with N-methylpyrrolidone (NMP). The mixture was stirred under action of a vacuum mixer until a mixed system became a positive electrode slurry with uniform fluidity. The positive electrode slurry was evenly applied on aluminum foil having a thickness of 12 The coated aluminum foil was baked in a five-stage oven with different temperatures and dried in an oven at 120° C. for 8 hours, followed by rolling and cutting, to obtain the positive electrode plate.

Preparation of a Negative Electrode Plate

A negative electrode active material graphite, a thickener sodium carboxymethyl cellulose (CMC-Na), a binder styrene-butadiene rubber, and a conductive agent acetylene black were mixed at a weight ratio of 97:1:1:1, and added into deionized water. The mixture was stirred under action of a vacuum mixer to obtain a negative electrode slurry. The negative electrode slurry was evenly applied on copper foil having a thickness of 8 The copper foil was dried at room temperature, and then transferred to an oven at 80° C. for 10 hours for drying, followed by cold pressing and slitting, to obtain the required negative electrode plate.

Preparation of an Electrolyte Solution

Ethylene carbonate, propylene carbonate, n-propyl propionate, and ethyl propionate were mixed in a mass ratio of 15:10:60:15 in a glovebox filled with argon gas and with qualified water content and oxygen content (solvent and additive should be normalized together), and then quickly added with 15 wt % of fully dried lithium hexafluorophosphate (LiPF₆). The mixture was stirred evenly, and a cooling measure was used to ensure that a temperature of the mixing vessel was kept below 10° C. during the process of adding LiPF₆. Then b wt % nitrile substance (specifically as shown in Table 1), c wt % compound represented by Formula 1 (specifically as shown in Table 1), 10 wt % fluoroethylene carbonate, and 0.3 wt % lithium difluorophosphate were added to the mixture, and the mixture was stirred again until uniform. After passing water content and free acid tests, the electrolyte solution in Comparative Example 1 was obtained.

Preparation of a Separator

A polyethylene separator with a thickness of 8 μm was used (from AsahiKASEI Corporation).

Preparation of a Lithium-Ion Battery

The positive electrode plate, the separator, and the negative electrode plate prepared above were sequentially stacked to ensure that the separator was located between the positive electrode plate and the negative electrode plate for separation, and then winding was performed to obtain a bare cell without liquid injection. The bare cell was placed in outer packaging foil, and the prepared electrolyte solution was injected into the dried bare cell. After processes such as vacuum packaging, standing, forming, shaping, and sorting, the lithium-ion battery required was obtained.

25° C. Room Temperature Cycling Test

Before the test, a thickness D₀ of a fully charged cell was measured. The battery was placed in an environment of (25±3°) C. for 3 hours, and when the cell body reached (25±3°) C., the battery was first charged to 4.2 V at 1 C, then charged to 4.5 V at 0.7 C, and then charged at a constant voltage of 4.5 V to a cut-off current of 0.05 C. After that the battery was discharged to 3 V at 0.5 C, and an initial capacity Q₀ was recorded. When cycles reached a required number of times, a discharge capacity obtained in this case was used as a capacity Q₂ of the battery to calculate a capacity retention rate (%). After that, the battery was fully charged and then the cell was taken out to measure a fully charged cell thickness D₂, and calculate a thickness change rate (%). The results are shown in Table 2. Formulas used are as follows:

Thickness change rate (%)=(D₂−D₀)/D₀×100%; and Capacity retention rate (%)=Q₂/Q₀×100%.

45° C. High Temperature Cycling Test

Before the test, a thickness D₀ of a fully charged cell was measured. The battery was placed in an environment of (45±3°) C. for 3 hours, and when the cell body reached (45±3°) C., the battery was first charged to 4.5 V at 0.7 C, and then charged to a cut-off current 0.05 C at a constant voltage of 4.5 V. After that the battery was discharged at 0.5 C, and an initial capacity Q₀ was recorded. Cycling was performed as described above. When cycles reached a required number of times, a discharge capacity obtained in this case was used as a capacity Q₃ of the battery to calculate a capacity retention rate (%). After that, the battery was fully charged and then the cell was taken out to measure a fully charged cell thickness D₃ in this case, and calculate a thickness change rate (%). The results are shown in Table 2. Formulas used are as follows:

Thickness change rate (%)=(D₃−D₀)/D₀×100%; and Capacity retention rate (%)=Q₃/Q₀×100%.

45° C. Interval Cycling Test

Before the test, a thickness D₀ of a fully charged cell was measured. The battery was placed in an environment of (45±3°) C. for three hours. When a cell body reached (45±3°) C., the battery was charged to 4.5 V at a constant current 0.7 C, and then charging to a cut-off current of 0.05 C at a constant voltage of 4.5V. The battery was stood at 45° C. for a specific period of time to ensure that a constant-current constant-voltage charging time plus the standing time was 24 hours, then discharged at 0.5 C, and an initial energy E₀ was recorded. Cycling was performed as described above. When cycles reached a required number of times, a discharge energy obtained in this case was used as an energy E₁ of the battery to calculate an energy retention rate (%). After that, the battery was fully charged and then the cell was taken out to measure a fully charged cell thickness D₄ in this case, and calculate a thickness change rate (%). The results are shown in Table 2. Formulas used are as follows:

Thickness change rate (%)=(D₄−D₀)/D₀×100%; and Energy retention rate (%)=E₁/E₀×100%.

60° C. High Temperature Storage Test

A thickness D₀ of a fully charged cell was measured at 25° C. A battery obtained after sorting was charged to 4.5 V at 0.7 C, then charged to a cut-off current of 0.05 C at a constant voltage 4.5 V, and then discharged to 3.0 V at a constant current 0.5 C. After that, the battery was charged to 4.5 V at 0.7 C, and then charged to a cut-off current 0.05 C at a constant voltage 4.5 V. After the battery was stood in an environment of 60° C. for 35 days, a fully charged cell thickness D₅ was measured, and a thickness change rate (%) was calculated. The record results are shown in Table 2. A formula used is as follows:

Thickness change rate (%)=(D₅−D₀)/D₀×100%.

### Examples 1 to 9 and Comparative Examples 2 to 7

Preparation processes of Examples 1 to 9 and Comparative Examples 2 to 7 differ from Comparative Example 1 in content (b and c) of a nitrile substance and a compound represented by Formula 1 in the electrolyte solution, whether voltage reduction is used in 45° C. cycling and 45° C. interval cycling, and a voltage reducing amplitude. In Examples 1 to 9 and Comparative Examples 2 to 7, voltage reduction starts separately after 150 cycles of 45° C. high temperature cycling and after 23 cycles of 45° C. high temperature interval cycling. The voltage reducing amplitudes and specific electrolyte solution formulas are shown in Table 1. The test results are listed in Table 2.

TABLE 1
Composition and content of additives in the electrolyte solution of Examples 1 to 9 and Comparative Examples 1 to 7

| | | Voltage | | | | | | | |
|---|---|---|---|---|---|---|---|---|---|
| | Voltage | reducing | | | | | | | |
| | reducing | amplitude | | | | | | | |
| | amplitude | in 45° C. | | | | 1,3- | | 1,3- | |
| | in 45° C. | interval | | | | propane | Ethylene | propene | |
| | cycling | cycling | | | 1,3,6- | sultone | sulfate | sultone | |
| | (V) | (V) | Succinonitrile | Adiponitrile | hexanetricarbonitrile | Content c of compound | | | (a + |
| | a | a | Content b of nitrile substance | | | represented by Formula 1 | | | b)/c |
| Comparative | 0 | 0 | 0.015 | 0.01 | 0.025 | 0.04 | / | / | 1.25 |
| Example 1 | | | | | | | | | |
| Comparative | 0 | 0 | 0.015 | 0.01 | 0.025 | 0.06 | / | / | 0.83 |
| Example 2 | | | | | | | | | |
| Comparative | 0.01 | 0.01 | 0.015 | 0.01 | 0.025 | 0.04 | / | / | 1.50 |
| Example 3 | | | | | | | | | |
| Comparative | 0.01 | 0.01 | 0.015 | 0.01 | 0.025 | 0.04 | 0.005 | / | 1.33 |
| Example 4 | | | | | | | | | |
| Comparative | 0.01 | 0.01 | 0.015 | 0.01 | 0.025 | / | / | 0.03 | 2.00 |
| Example 5 | | | | | | | | | |
| Comparative | 0.12 | 0.12 | 0.015 | 0.01 | 0.025 | 0.04 | / | / | 4.25 |
| Example 6 | | | | | | | | | |
| Comparative | 0.12 | 0.12 | 0.015 | 0.01 | 0.025 | 0.02 | / | / | 8.50 |
| Example 7 | | | | | | | | | |
| Example 1 | 0.06 | 0.06 | 0.015 | 0.01 | 0.025 | 0.03 | / | / | 3.67 |
| Example 2 | 0.06 | 0.06 | 0.015 | 0.01 | 0.03 | 0.03 | / | / | 3.83 |
| Example 3 | 0.06 | 0.06 | 0.015 | 0.01 | 0.025 | 0.04 | / | / | 2.75 |
| Example 4 | 0.06 | 0.06 | 0.015 | 0.01 | 0.025 | / | / | 0.03 | 3.67 |
| Example 5 | 0.06 | 0.06 | 0.015 | 0.01 | 0.025 | 0.04 | 0.005 | / | 2.44 |
| Example 6 | 0.07 | 0.07 | 0.015 | 0.01 | 0.025 | 0.04 | / | / | 3.00 |
| Example 7 | 0.08 | 0.08 | 0.015 | 0.01 | 0.025 | 0.04 | / | / | 3.25 |
| Example 8 | 0.09 | 0.09 | 0.015 | 0.01 | 0.025 | 0.04 | / | / | 3.50 |
| Example 9 | 0.09 | 0.09 | 0.015 | 0.01 | 0.025 | 0.03 | / | / | 4.67 |

TABLE 2
Comparison between experimental results of batteries
in Examples 1 to 9 and Comparative Examples 1 to 7

| | 1000 cycles in | | 500 cycles in | | 100 cycles in 45° | | |
|---|---|---|---|---|---|---|---|
| | 25° C. cycling | | 45° C. cycling | | C. interval cycling | | 60° C./35 days |
| | Thickness | Capacity | Thickness | Capacity | Thickness | Capacity | Thickness |
| | change | retention | change | retention | change | retention | change |
| | rate (%) | rate (%) | rate (%) | rate (%) | rate (%) | rate (%) | rate (%) |
| Comparative | 10.5 | 80.4 | 11.3 | 75.3 | 10.4 | 74.3 | 9.4 |
| Example 1 | | | | | | | |
| Comparative | 14.2 | 70.2 | 10.5 | 76.3 | 9.8 | 74.8 | 7.5 |
| Example 2 | | | | | | | |
| Comparative | 10.4 | 80.5 | 10.6 | 74.8 | 9.9 | 73.5 | 9.3 |
| Example 3 | | | | | | | |
| Comparative | 9.8 | 81.2 | 10.2 | 75.2 | 9.7 | 73.7 | 8.9 |
| Example 4 | | | | | | | |
| Comparative | 13.4 | 71.4 | 10.3 | 75.4 | 9.7 | 74.1 | 8.7 |
| Example 5 | | | | | | | |
| Comparative | 10.2 | 80.3 | 9.4 | 73.1 | 9.5 | 72.7 | 9.5 |
| Example 6 | | | | | | | |
| Comparative | 10.6 | 80.6 | 9.9 | 71.7 | 9.7 | 71.3 | 11.2 |
| Example 7 | | | | | | | |
| Example 1 | 9.3 | 84.1 | 9.2 | 79.2 | 9.1 | 77.3 | 9.8 |
| Example 2 | 9.5 | 83.6 | 8.7 | 80.6 | 8.9 | 78.3 | 9.0 |
| Example 3 | 9.7 | 83.9 | 8.9 | 80.4 | 8.6 | 78.5 | 9.2 |
| Example 4 | 13.7 | 70.8 | 8.5 | 80.9 | 8.6 | 78.7 | 8.9 |
| Example 5 | 9.4 | 84.7 | 8.6 | 81.3 | 8.3 | 79.1 | 8.7 |
| Example 6 | 9.6 | 83.8 | 8.3 | 81.0 | 8.0 | 79.3 | 9.3 |
| Example 7 | 9.3 | 84.1 | 8.0 | 80.9 | 7.5 | 79.0 | 9.5 |
| Example 8 | 9.3 | 83.7 | 7.7 | 80.3 | 7.2 | 78.6 | 9.5 |
| Example 9 | 9.1 | 84.3 | 8.1 | 79.3 | 7.8 | 78.1 | 9.9 |

### Examples 10-23

Examples 10-23 were conducted with reference to Example 5, except that cycles before voltage reduction in 45° C. high temperature cycling, cycles before voltage reduction in 45° C. high temperature interval cycling, selection of a nitrile substance, and the like were varied, as shown in Table 3. Tests were performed separately, and the test results were recorded as shown in Table 4.

TABLE 3
Setting conditions in Examples 10-23

| | Cycles before voltage | Cycles before voltage | |
|---|---|---|---|
| | reduction in 45° C. | reduction in 45° C. | |
| | cycling | interval cycling | Combination of nitrile compound |
| Example 5 | 150 | 23 | Succinonitrile:adiponitrile:1,3,6- |
| | | | hexanetricarbonitrile = 0.015:0.01:0.025 |
| Example 10 | 160 | — | Same as that in Example 5 |
| Example 11 | 170 | — | Same as that in Example 5 |
| Example 12 | 180 | — | Same as that in Example 5 |
| Example 13 | 190 | — | Same as that in Example 5 |
| Example 14 | 200 | — | Same as that in Example 5 |
| Example 15 | — | 21 | Same as that in Example 5 |
| Example 16 | — | 22 | Same as that in Example 5 |
| Example 17 | — | 24 | Same as that in Example 5 |
| Example 18 | — | 25 | Same as that in Example 5 |
| Example 19 | 150 | 23 | Succinonitrile:adiponitrile:glycerol |
| | | | trinitrile = 0.015:0.01:0.025 |
| Example 20 | 150 | 23 | 3-methoxypropionitrile:succinonitrile:1,3,6- |
| | | | hexanetricarbonitrile = 0.015:0.01:0.025 |
| Example 21 | 150 | 23 | Succinonitrile:glutaronitrile:1,3,6- |
| | | | hexanetricarbonitrile = 0.015:0.01:0.025 |
| Example 22 | 150 | 23 | Adiponitrile:1,2-bis(2-cyanoethoxy)ethane:1,3,6- |
| | | | hexanetricarbonitrile = 0.015:0.01:0.025 |
| Example 23 | 150 | 23 | 3-methoxypropionitrile:adiponitrile:1,3,6- |
| | | | hexanetricarbonitrile = 0.015:0.01:0.025 |

TABLE 4
Comparison of experimental results of batteries in Examples 10-23

| | 1000 cycles in | | 500 cycles in | | 100 cycles in 45° | | |
|---|---|---|---|---|---|---|---|
| | 25° C. cycling | | 45° C. cycling | | C. interval cycling | | 60° C./35 days |
| | Thickness | Capacity | Thickness | Capacity | Thickness | Capacity | Thickness |
| | change | retention | change | retention | change | retention | change |
| | rate (%) | rate (%) | rate (%) | rate (%) | rate (%) | rate (%) | rate (%) |
| Example 5 | 9.4 | 84.7 | 8.6 | 81.3 | 8.3 | 79.1 | 8.7 |
| Example 10 | 9.6 | 84.5 | 8.8 | 80.9 | — | — | 8.9 |
| Example 11 | 9.4 | 84.8 | 9.1 | 80.4 | — | — | 8.7 |
| Example 12 | 9.3 | 85.1 | 9.3 | 80.1 | — | — | 8.9 |
| Example 13 | 9.4 | 84.9 | 9.3 | 79.8 | — | — | 8.7 |
| Example 14 | 9.2 | 84.6 | 9.5 | 79.4 | — | — | 8.6 |
| Example 15 | 9.5 | 84.8 | — | — | 8.0 | 79.8 | 8.5 |
| Example 16 | 9.3 | 84.5 | — | — | 8.2 | 79.5 | 8.3 |
| Example 17 | 9.3 | 84.5 | — | — | 8.7 | 78.7 | 8.2 |
| Example 18 | 9.6 | 84.8 | — | — | 9.0 | 78.4 | 8.5 |
| Example 19 | 9.5 | 84.6 | 8.9 | 81.0 | 8.5 | 78.7 | 9.1 |
| Example 20 | 9.1 | 85.2 | 8.7 | 81.2 | 8.8 | 78.9 | 8.9 |
| Example 21 | 9.3 | 84.5 | 8.9 | 81.4 | 8.7 | 78.6 | 9.2 |
| Example 22 | 9.3 | 84.8 | 9.2 | 81.2 | 8.5 | 78.4 | 9.4 |
| Example 23 | 9.2 | 84.9 | 8.4 | 81.5 | 8.6 | 78.9 | 9.1 |

It may be learned from Table 2 and Table 4 that all batteries prepared in the examples of the present disclosure have achieved better electrical performance. Based on magnitude of improvement of the capacity retention rate and the thickness expansion rate during cycling of the batteries, it can be proved that good 45° C. high temperature cycling performance and good 45° C. high temperature interval cycling performance can be achieved, and good 25° C. cycle performance and 60° C. high temperature storage performance can also be maintained by using a specific voltage reducing amplitude in combination with a specific nitrile substance and a compound shown in Formula 1 that meet a specific relationship.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

1. A battery, wherein the battery comprises an electrolyte solution comprising an organic solvent, a lithium salt, a nitrile substance, and a compound represented by Formula 1, 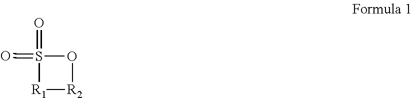
wherein R₁ is non-existent or selected from an —O— or C₂₋₆ alkenylene group, R₂ is non-existent or selected from a C₁₋₆ alkylidene or C₂₋₆ alkenylene group, and R₁ and R₂ are not non-existent simultaneously and are not a C₂₋₆ alkylene group simultaneously; and
the battery satisfies the following relationship:
0.055≤a≤0.1;0.03≤b≤0.07;0.03≤c≤0.05; and 1.7≤(a+b)/c≤5.7,
wherein a denotes a voltage reducing amplitude, in a unit of V, obtained during 45° C. high temperature cycling or 45° C. high temperature interval cycling;
b denotes a percentage of a mass of the nitrile substance in the electrolyte solution in a total mass of the electrolyte solution; and
c denotes a percentage of a mass of the compound represented by Formula 1 in the electrolyte solution in a total mass of the electrolyte solution.

2. The battery according to claim 1, wherein a capacity retention rate of the battery is not less than 79.2% after 500 cycles in 45° C. high temperature cycling, and/or a thickness change rate of the battery is not greater than 9.2% after 500 cycles in 45° C. high temperature cycling.

3. The battery according to claim 2, wherein a voltage reduction strategy used for the battery in the 45° C. high temperature cycling is as follows: performing full charge and discharge initially in a corresponding voltage range; and after 150-200 cycles, performing voltage reduction and continuing to cycle, wherein the voltage reducing amplitude, namely a, ranges from 0.055 V to 0.1 V.

4. The battery according to claim 1, wherein a capacity retention rate of the battery is not less than 77.3% after 100 cycles in 45° C. high temperature interval cycling, and/or a thickness change rate of the battery is not greater than 9.1% after 100 cycles in 45° C. high temperature interval cycling.

5. The battery according to claim 4, wherein a voltage reduction strategy used for the battery in the 45° C. high temperature interval cycling is as follows: performing full charge and discharge initially in a corresponding voltage range; and after 20-25 cycles, performing voltage reduction and continuing to cycle, wherein the voltage reducing amplitude, namely a, ranges from 0.055 V to 0.1 V.

6. The battery according to claim 1, wherein the nitrile substance is selected from one or more of the following compounds: succinonitrile, glutaronitrile, adiponitrile, pimeliconitrile, suberonitrile, sebaconitrile, 1,3,6-hexanetricarbonitrile, 3-methoxypropionitrile, glycerol trinitrile, or 1,2-bis(2-cyanoethoxy)ethane.

7. The battery according to claim 1, wherein in Formula 1, R₁ is non-existent or selected from an —O— or C₂₋₃ alkenylene group, R₂ is non-existent or selected from a C₁₋₃ alkylidene or C₂₋₃ alkenylene group, and R₁ and R₂ are not non-existent simultaneously and are not a C₂₋₃ alkylene group simultaneously.

8. The battery according to claim 7, wherein the compound represented by Formula 1 is selected from one or more of the following compounds: 1,3-propane sultone, 1,3-propene sultone, or ethylene sulfate.

9. The battery according to claim 1, wherein 0.056≤a≤0.08; and/or
0.04≤b≤0.06.

10. The battery according to claim 1, wherein 2.44≤(a+b)/c≤3.83.

11. A method for improving battery cycling performance, comprising:
performing cyclic charging and discharging on the battery according to claim 1 in a range of a first preset voltage;
when a quantity of cycles is within a preset quantity of cycles, reducing the first preset voltage by a preset amplitude to obtain a second preset voltage, wherein a value of the preset amplitude ranges from 0.055 V to 0.1 V; and
performing charging and discharging on the battery in a range of the second preset voltage.

12. The method for improving battery cycling performance according to claim 11, wherein the performing cyclic charging and discharging on the battery in a range of a first preset voltage comprises:
(A) performing constant-current charging on the battery by using a first preset current until the battery is charged to the first preset voltage;
(B) performing constant-voltage charging on the battery by using the first preset voltage until the battery is charged to a cut-off current;
(C) discharging the battery by using a second preset current; and
iteratively performing steps (A) to (C) to complete cyclic charging and discharging of the battery, wherein
the performing charging and discharging on the battery in a range of the second preset voltage comprises:
performing constant-current charging on the battery by using the first preset current until the battery is charged to the second preset voltage;
performing constant-voltage charging on the battery by using the second preset voltage until the battery is charged to the cut-off current; and
discharging the battery by using the second preset current.

13. The method for improving battery cycling performance according to claim 12, wherein the preset quantity of cycles ranges from 150 to 200.

14. The method for improving battery cycling performance according to claim 11, wherein the performing cyclic charging and discharging on the battery in a range of a first preset voltage comprises:
(D) performing constant-current charging on the battery by using a third preset current until the battery is charged to the first preset voltage;
(E) performing constant-voltage charging on the battery by using the first preset voltage until the battery is charged to a cut-off current;
(F) discharging the battery by using a fourth preset current when a sum of a duration of the constant-current charging, a duration of the constant-voltage charging, and a first time is within a preset time threshold, wherein the first time is a duration during which the battery stays at a preset temperature after constant-voltage charging; and
iteratively performing steps (D) to (F) to complete cyclic charging and discharging of the battery, wherein
the performing charging and discharging on the battery in a range of the second preset voltage comprises:
performing constant-current charging on the battery by using the third preset current until the battery is charged to the second preset voltage;
performing constant-voltage charging on the battery by using the second preset voltage until the battery is charged to the cut-off current; and
discharging the battery by using the fourth preset current when a sum of the duration of the constant-current charging, the duration of the constant-voltage charging, and a second time is within the preset time threshold, wherein the second time is a duration during which the battery stays at the preset temperature after constant-voltage charging.

15. The method for improving battery cycling performance according to claim 14, wherein the preset quantity of cycles ranges from 20 to 25.

16. The method for improving battery cycling performance according to claim 14, further comprising:
determining a sum of the first time, a duration of the constant-current charging, and a duration of the constant-voltage charging used when cyclic charging and discharging is performed on the battery in a range of the first preset voltage; and
determining a sum of the second time, the duration of the constant-current charging, and the duration of the constant-voltage charging used when cyclic charging and discharging is performed on the battery in a range of the second preset voltage.

17. The method for improving battery cycling performance according to claim 14, wherein the preset time threshold ranges from 20 hours to 30 hours.

18. The method for improving battery cycling performance according to claim 11, further comprising:
measuring a temperature of the battery occurred after the battery is left at a preset temperature for a preset time, wherein
the performing cyclic charging and discharging on the battery in a range of a first preset voltage comprises:
after the temperature of the battery reaches the preset temperature, performing cyclic charging and discharging on the battery in the range of the first preset voltage.

19. An electronic device, comprising a memory and a processor, wherein the memory stores a computer program, and when executing the computer program, the processor performs the following steps:
performing cyclic charging and discharging on a battery in a range of a first preset voltage;
when a quantity of cycles is within a preset quantity of cycles, reducing the first preset voltage by a preset amplitude to obtain a second preset voltage, wherein a value of the preset amplitude ranges from 0.055 V to 0.1 V; and
performing charging and discharging on the battery in a range of the second preset voltage.

20. A non-transitory computer-readable storage medium on which a computer program is stored, wherein when the computer program is executed by a processor, the following steps are performed:
performing cyclic charging and discharging on a battery in a range of a first preset voltage;
when a quantity of cycles is within a preset quantity of cycles, reducing the first preset voltage by a preset amplitude to obtain a second preset voltage, wherein a value of the preset amplitude ranges from 0.055 V to 0.1 V; and
performing charging and discharging on the battery in a range of the second preset voltage.
